(19) United States
(12) Patent Application Publication
(10) Pub. No.: US 2009/0132487 A1
(43) Pub. Date: May 21, 2009

(54) SYSTEM AND METHOD FOR VIDEO CALL BASED CONTENT RETRIEVAL, DIRECTORY AND WEB ACCESS SERVICES

(76) Inventor: Zvi Haim Lev, Tel Aviv (IL)

Correspondence Address: SUGHRUE MION, PLLC, 2100 PENNSYLVANIA AVENUE, N.W., SUITE 800, WASHINGTON, DC, 20037, US

(21) Appl. No.: 11/943,715

(22) Filed: Nov. 21, 2007

(51) Int. Cl. G06F 17/30; G06F 15/16; H04L 9/00; G06F 7/00; G10L 11/00

(52) U.S. Cl. 707/3; 709/203; 707/6; 707/5; 726/3; 704/275; 707/E17.014; 707/E17.017

(57) ABSTRACT

A system and method for the retrieval of electronic information, comprising a remote device for inputting information requests, and for receiving and displaying received information; a communication network for establishing a communication link between the remote device and an information network; a protocol stack for receiving and decoding information requests from the remote device; an RTP dispatcher for sending audio visual content to the protocol stack; a video encoder for encoding video content in a format suitable for display on the remote device; a DTMF decoder for determining what DTMF information was conveyed by the remote device; a rendering engine to render on the screen of the remote device possible matches to the data entries being made by the user, and to start delivering content to the user.

### CROSS-REFERENCE TO RELATED APPLICATIONS

This application claims the benefit of U.S. Provisional Patent Application Ser. No. 60/864,454, filed on Nov. 22, 2006, entitled “System and Method for Video Call Based Content Retrieval, Directory and Web Access Services”, which is incorporated herein by reference in its entirety.

### BACKGROUND OF EXEMPLARY EMBODIMENTS OF THE INVENTION

The present invention relates generally to the field of content access and content search. Nowadays users of computing platforms tend to use various data entry methods to search for and locate desired content. Typical methods include text entry of search terms using a Key Pad, or clicking a selection from a list with a Computer mouse. All these methods have disadvantages or defects. In mobile devices, for example, the means for user input are limited, and the current methods suffer from reliability and speed issues. Hence, there is a great need to find methods that will minimize the number of distinct user actions (such as, e.g., keystrokes or clicks) necessary for choosing the right content.

The embodiments described herein are illustrative and non-limiting. Definitions are provided solely to assist one of ordinary skills in the art to better understand these illustrative, non-limiting embodiments. As such, these definitions should not be used to limit the scope of the claims more narrowly that the plain and ordinary meaning of the terms recited in the claims. With that caveat, the following definitions are used:

“Computer” means any

computer,

combination of Computers, or

other equipment performing computations,

that can process the information sent by a remote device. Prime examples would be (1) the local processor in an imaging device, (2) a remote server, or (3) a combination of the local processor and the remote server.

“Key Pad” means any equipment for entry of alphanumeric information, such as, e.g., a mobile phone's numeric Key Pad, or a touch screen with alphanumeric keys marked on it. Entry of information may also be by voice or other audio means, in which the audio signal is converted by machine into alphanumeric information. The term “Key Pad” includes also equipment that receives audio input, equipment that converts audio input into alphanumeric information, and equipment that both receives and converts the audio input.

“Retrieval” means searching, accessing, and purchasing, content, or any subset of those three activities.

“Video Call” means a two-way and one-way call, performed via electronic devices, which includes (but not necessarily exclusively) video and/or audiovideo material. Some examples of electronic devices which perform Video Calls include a Computer with a web-cam, or a cell phone with a camera, or any other device with the capability of audio or audiovisual capture. Such audio or audiovisual capture includes (but not by way of limitation) any audiovisual connection performed by mobile device with video streaming and imaging capability. A Video Call may use a variety of protocol standards, examples of which are H.321, H.323, and 3G.324M.

### DESCRIPTION OF THE RELATED ART

The Retrieval of content is currently a large and growing market all over the world. There are several established methods of facilitating such content Retrieval through a remote device. Some examples of such methods include:

Imaging—where the user takes a picture/video of a barcode, an alphanumeric code or a photo/logo of the relevant content.

Interactive Video Response—where the user makes a Video Call to a number to access certain content. The video channel is used to display to the user the different menus and options, and the user makes choices using the DTMF functionality of the handset.

Interactive Voice Response (IVR)—where the user makes a voice call to a number to access certain content (e.g., Weather Forecast, Traffic Conditions, etc.). During the voice call, the user may also make choices or perform other operations using the Dual Tone Multiple Frequency (DTMF) functionality of a remote device.

On Device Portals—where the user types on a Key Pad, and software resident on the remote device tries to assess the keyword(s) the user is trying to type. For example, one relatively well known On Device Portal is Tegic's T9 system for entry of words in Short Message Service (SMS) messages.

Short Message Services (SMS)—where the user prepares a short text message and sends it to a service number. The SMS message contains a numeric code or codeword or other form, and indicates the content desired by the user. For example, to download the latest ringtone by an artist FreedomZ, the user may send an SMS message containing the keyword “FreedomZ123”. The various keywords or codes are advertised to the user typically by the content provider, or by the service provider.

Voice Recognition—where the user speaks words (or names of letters and/or digits) during a voice/Video Call, and the server converts them to digital information.

WAP/Web browsing—where the user indicates the selected content by pressing on the relevant link, and/or by filling some WAP/Web form and submitting the result for search.

While they are currently popular, these methods have certain drawbacks:

Imaging—the imaging operation (1) requires a functional camera on the remote device, and (2) requires illumination conditions sufficient for imaging. Imaging also requires (3) the presence of a visual tag symbolizing the content. Placement of the tag is possible, but complicating. Someone must decide a tag is necessary, design the tag, and place the tag on a server. Moreover, the user must be educated in the use of the tag. Although all of this is possible, the use of a tag is both time-consuming and expensive.

Interactive Video Response—the (1) need to display menus, and the (2) need to have the user select from these menus, lead to a situation where many clicks are required, with delays in between required for the user to read the updating screen. This is a situation similar to the WAP/Web browsing scenario. Interactive Video Response and browsing are similar in that for each one, there are thousands of terms/objects to choose from, which means that the user will be exposed to multiple menus before the desired term/object is identified and displayed. The display of multiple screens is tiring and confusing to users, and typically reduces user interest in Retrieving content. Interactive Video Response and browsing are different in that the Video IVR screen is generally smaller, less detailed, and more difficult to read, than the browsing screen, and that is due in large part to bandwidth limitations of video channels.

Interactive Voice Response—(1) Since the feedback supplied by the system is only auditory, a long time may be required for the user to verify the code he or she has entered, and (2) further, it is very hard to correct during entry an error in auditory code. Furthermore, (3) if the user has selected some content, it is difficult, in a voice call, to provide the user with verification for the type of content he or she has chosen (e.g., a wallpaper). Also, (4) since the audio channel is used, the user must hold the phone next to his or her ear during the process, which makes the data entry on the Key Pad slower and more prone to error.

On Device Portals (ODP)—On Device Portals (1) require the installation of software on the device—hence, they cannot serve as a truly generic system for the users of all phones. This installation creates additional problems, such as the need to consistently maintain and update the software at the remote, the fact that different ODPs will belong to different brands and will therefore require different access methods of the user, and the fact that becomes difficult to change ODPs as a user becomes accustomed to one or two specific brands. For the user, a server oriented solution to content Retrieval will allow the user to Retrieve content irrespective of the identity of policies of the user's carrier, and regardless of the remote terminal's brand or place of purchase.

Short Message Services—the process of sending an SMS and receiving the SMS reply is (1) slow and (2) does not enable correction of the entered code during or after entry. Thus, (3) the retrieved content may be incorrect yet the user will be billed for it.

Voice Recognition—(1) the reliability of voice based entry can be quite low, especially in the presence of background noise and/or with speakers that the system is not trained for. Another important issue is (2) privacy—the user's having to say aloud what he or she wants can be embarrassing for the user (e.g., when accessing sensitive financial information personal to the user, or when searching for adult content).

WAP/Web browsing—the process of link selection when many content items are available (1) requires that the user leaf through numerous and/or long menus and lists. This is slow, since mobile browsing is considerably slower than Internet browsing, due to both the lower bandwidth and the lower browser CPU resources. Mobile browsing is also tiring for the user, in large part due to the slowness of the browsing process. In addition, (2) the process of data entry in WAP/Web forms is static in the sense that until the user finishes the data entry and presses the “submit” button, there is no interactivity. Furthermore, (3) typically in WAP browsers, features such as predictive text are not functional in form-filling fields. Another drawback of WAP/WEB browsing is (4) that the user must have a data plan to use browsing properly.

### SUMMARY OF EXEMPLARY EMBODIMENTS OF THE INVENTION

Exemplary embodiments of the present invention solve the above-mentioned drawbacks by combining the best characteristics of the DTMF (Dial Tone Multiple Frequency) input presently used in Interactive Voice Response, with the advantages of remote processing and immediate visual feedback made possible using Video Calls.

Some exemplary embodiments of the current invention provide alternative or complementary methods of solving drawbacks, in the context of a Video Call session between a user and a server. The user input is accomplished using the numeric or alphanumeric Key Pad of a remote device, while the feedback to the user is provided visually using the video link between the server and the user's remote device.

Some exemplary embodiments of the present invention are based on a combination of user data entry via key-presses on a remote device, server based recognition of the desired content based on the user entry and a database of possibilities, and a video downlink to the user through which the server displays to the user the possible choices based on the user's input.

Compared to existing systems, the use of a video channel to display the result or options speeds up greatly the data entry process as the user does not have to pause data entry to listen to the server feedback after data entry.

Compared to on device portals and other client based solutions, the reliance on a server to do the heavy processing removes the need for software installation and upgrades. This would also mean a smaller memory footprint on the remote device, less processing at the remote device, and less power consumption by the remote device, all of which are advantages for any remote device and particularly for remote mobile devices.

As an example of the application of one exemplary embodiment of the invention, a user could type the name of a music artist/band to access content on sale by that artist/band. For example, the user could choose the artist “Madonna” by typing 6-2-3-6-6-6-2, and the term “Madonna” would be chosen by the server as soon as there are no other names in the database conforming to this key-press sequence (e.g., 6-2-3-6 might suffice).

As another example of the application of exemplary embodiment, the user could by typing the ISBN number of a book on display, or typing the keyword “taxi” based on the multiple key-press method used for SMS entry (8-2-9-9-4-4-4), reach information about the said book or order a taxi/view taxi stations numbers.

In one exemplary embodiment of the invention, the user makes a Video Call to the server for specific content/service—e.g. a call to a flight booking service or a ringtone download service. Hence, the nature of the service itself (as indicated by the user's choice of number to call) already narrows down the user's potential choice of words/terms, as compared to the full range of words used in the English language. Thus, for example, a ring-tone service might offer a few thousand ring-tones at any given time, from a range of a few hundred popular artists/albums identifiable by their names. Similarly, a user calling a flight booking service will need to choose a city of origin from just a few hundreds of names. The narrowing down of the list of searched terms to a few hundreds or thousands is very valuable since it typically narrows down the number of distinct key-presses required for the identification of the word/term to about 3 or 4. Related art systems store and access entire languages, such as the English language. This approach will function, but it is slow and cumbersome. Exemplary embodiments of the current invention can operate on entire languages such as English, but they can operate also on much smaller databases made up of only a few, to tens of thousands of, terms.

In one exemplary embodiment of the invention, the server displays to the user a list of the current possibilities based on the key-presses. It is possible to present these possibilities as a numbered list enabling the user to finalize the choice. For example, in a music-artist search, typing ‘6-2-6’ on the Key Pad could result in the list of “1. Mandy Moore 2. Manfred Mann 3. Manhattans (The) 4. Nancy Sinatra”. (A Key Pad will have the letter “N” on the same button as “M”, which explains why “Nan” will appear as option beside “Man”.) By offering this feature, an exemplary embodiment of the present invention provides some of the advantages of on-device portals, while maintaining the simplicity and familiarity of a DTMF, server-based service. A similar list would have been impractical in a voice centered service as the time to listen to all the choices would be prohibitive and there would be a greater chance that the users will mix-up the options.

Some exemplary differences between related art and some exemplary embodiments of the present invention are thus:

Utilization of the video channel of a mobile Video Call—the server feedback to the user, including user key presses, potential search term results, and other directions (e.g., “press # to restart typing”) or feedback (e.g., “No Search terms found”) are provided using the video channel (potentially with additional audio feedback). Thus, the search may be silent.

Display of a list of potential keywords fitting key-presses—the use of a downlink video channel allows for the display of several potential search terms (including, e.g., popular spelling mistakes or typing mistakes) from which the user can further narrow down the list to a single option by typing more letters or by choosing from a numbered list. This kind of in-process feedback would have been too cumbersome to implement using an audio-downlink as in traditional Interactive Voice Response.

It should be stressed that one novel aspect of some exemplary embodiments of the present invention is providing a data-base mechanism for minimizing user error and typing effort. (This may or may not be combined with the advantage of minimizing keystrokes, but it is not dependent on minimizing keystrokes.) Thus, for example, the T9 method by Tegic reduces the number of keystrokes by using a database of words in the English language and requiring that the user press each key associated with 3 letters only once, regardless of the desired letter. Exemplary embodiments of the invention described here could just as well work in the convention of multiple key-presses for a single letter, yet save the user time and effort by comparing the key-press sequence with a database of names or search terms.

Similarly, exemplary embodiments of the invention described herein could be used to enter a phone number or an ISBN code, and the user will enter a database that will save typing the full number and/or correct for mistakes in the entry. Thus, for example, if a user types the number 1-800-356933777, which does not exist, the system could identify the user is probably trying to type 1-800-356-9377 (1-800-FLOWERS) and provide this match for the user to choose. This feature, Retrieval by phone number, or by ISDN number, or by any alphanumeric information beyond generic words, is an advantage over related art systems and methods.

Additional differences between the related art and exemplary embodiments of the present invention, and additional advantages of exemplary embodiments of the present invention over the related art, are explained further herein in the specification and claims.

### BRIEF DESCRIPTION OF THE DRAWINGS

Various other aspects, features and attendant advantages of the exemplary embodiments of the present invention will become fully appreciated as the same become better understood when considered in conjunction with the accompanying detailed description, the appended claims, and the accompanying drawings, in which:

FIG. 1 is a schematic diagram of the various system components of an exemplary embodiment of the present invention.

FIG. 2 is a schematic diagram of a keyword matching algorithm used during the user keypress typing to determine the list of potential keywords and to display them to the user according to an exemplary embodiment of the present invention.

FIG. 3 is a depiction of several examples of how the predictive text input system could be used to direct users to services and content based on existing URLs, phone numbers and keywords according to an exemplary embodiment of the present invention.

### DETAILED DESCRIPTION OF THE EXEMPLARY EMBODIMENTS

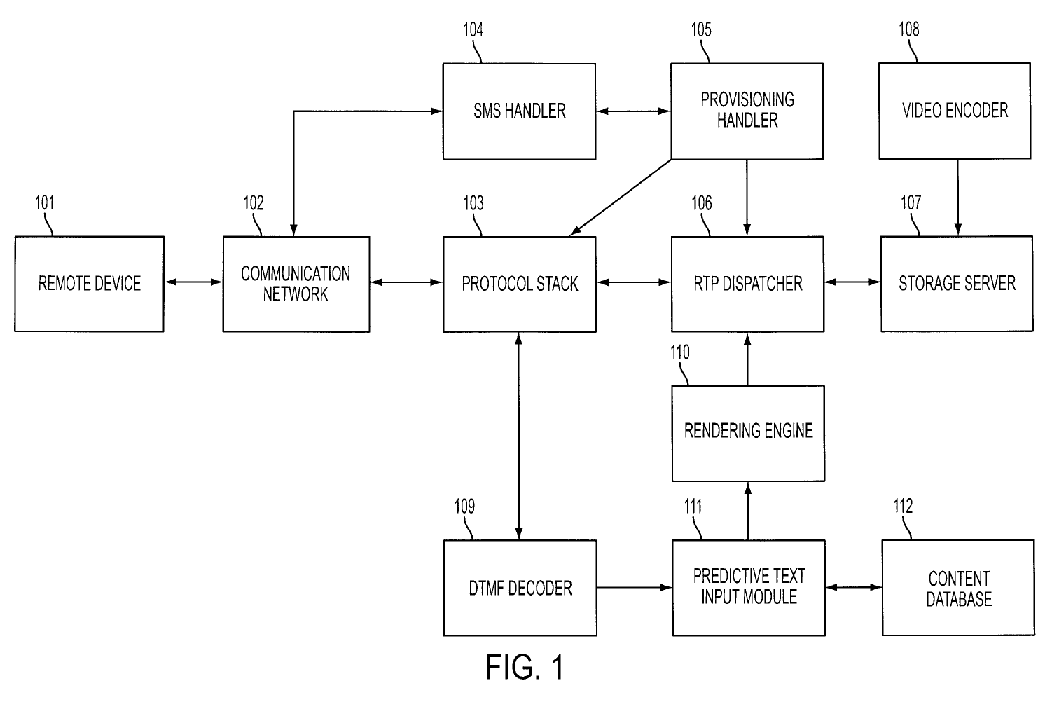

The components of the system are shown in FIG. 1. The user Remote Device 101 is used to initiate a video telephony session through the wireless or wire-line Communication Network 102. The Protocol Stack 103 handles the communication and in particular the detection of incoming DTMF or other input signals. The communication protocol used could be 3G-324M, or any similar such protocol. The SMS Handler 104 is a software component resident on the server that interacts with the carrier's SMS Center either directly or through a service broker. It can send an SMS to a mobile or a fixed line remote terminal. The SMS Handler can be used to send SMS information or WAP links to the user's Remote Device during or after the Video Call. The Provisioning Handler 105 maintains the list of users eligible for the service, including information such as their MSISDN number and billing status. The Provisioning Handler 105 may also interface with external providers supplying credit card or lists of users provisioned for the service. The Provisioning Handler 105 can process incoming user requests, send SMS mobile terminated (MT) messages, and affect the Video Call using billing logic. As examples of affecting the Video Call, the Provisioning Handler 105 can make a warning message appear on the Video Call through the Real-Time Transport Protocol (RTP) Dispatcher 106, or close a Video Call session altogether via the control of the Protocol Stack 103.

The RTP Dispatcher 106 sends RTP packets of audio visual content to the Protocol Stack 103. RTP Dispatcher 106 may do the RTP packaging on-the-fly, or may use pre-packaged RTP content, but in either case the content can be optimized to utilize the Video Call bandwidth and the specific type of content sent. For example, audio and video packets may be interleaved in optimal manners to ensure audiovisual synchronization. The RTP Dispatcher 106 also decides which version of the video clip to play to the user based on the handset information provided by the Protocol Stack 103. The Video Encoder 108 encodes video in a format suitable for display during a Video Call according to optimal encoding methods (with or without human intervention and guidance), and stores the pre-prepared content clips (potentially in several versions to optimize for different handsets) on the Storage Server 107. The DTMF Decoder 109 uses the information extracted from the data stream to detect which keys the user has pressed, at what exact time. and for which precise duration. It can apply further logic to delete (or give lower weight) to key-presses which appear to be in error due to their timing and/or length.

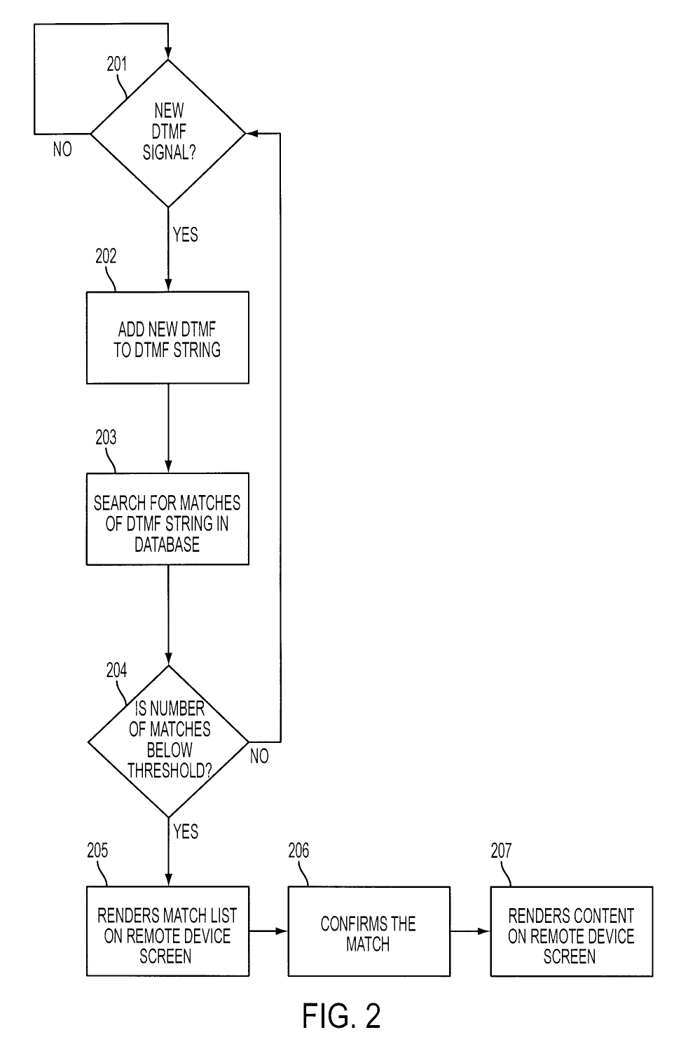

The Predictive Text Input Module 111 utilizes the DTMF string supplied by the DTMF Decoder 109 and the list of potential inputs stored in the Content Database 112, to predict the potential words and numbers the user is entering before the data entry is completed. The Predictive Text Input Module 111 may employ an algorithm such as that described in FIG. 2. When the Predictive Module has identified a list of candidates, the Rendering Engine 110 is used to render on the screen of the user's Remote Device 101 the resulting match (or matches), and to request authorization or simply to start delivering the content. Rendering on the screen can happen when, for example, one candidate has been identified, that is, the user has typed in sufficient letters/numbers for a unique identification of the word/serial number.

An exemplary embodiment of the algorithm for determining the desired search term from the user typing is presented in FIG. 2, in which data entry is by DTMF signal.

The system maintains a list of all key-presses made by the user as part of the search term entry. As a new key is pressed, a New DTMF Signal 201 is created. This system then adds this New DTMF Signal to a DTMF String 202 that continues to grow with the addition of new strings. The system then performs a Search for Matches of the DTMF String in the Database 203 or databases that is, or are, accessed to meet the user's request. The particular database accessed is tied to the application requested by the user. For example, the user may request data based continually updated such as those provided by Google or Yahoo, or databases recommended by a list of popular Web sites such as lists provided by the company Alexa, or databases provided by the service provider providing the communication system to the user, or by some other database defined by the user.

One example of a specific database search could be a ring-tone search based on an artist's name which would lead to an artist database. Conversely, a ring-tone search based on an album name would lead to an album database. The type of search term (album name, artist name, etc.) could be indicated by a user choice (e.g., from an initial menu). The database could also contain misspelled entries to account for user errors in spelling and/or typing. For example, in an artist-name database, a popular artist like Madonna could have several entries “Maddonna, Madona, Madonna” to accommodate for typing errors.

In stage 204, the system determines if the Number of Matches is Below a Threshold number that has been defined. This threshold can be a function of the screen size, human interface factors, quality of image, relative likelihood of the terms based on statistical inference, or other factors. For example, in some applications the threshold may be “1”, indicating that a value is presented to the user only when a single entry in the database fully matches the key-press sequence. In other applications, the threshold may also be a function of the number of key-presses, the local weight given to specific entries, or other factors. For example, a rule can be implemented that until 5 key-presses the threshold is 1 (so the match is displayed only if there is one sure match), while above 5 key-presses the threshold is 3 (so all matches will be displayed if there are 3 or less matches).

Once the threshold has been crossed, the system Renders the Match List on the Remote Device Screen 205. It is possible to order the matches in the list so that terms which are more popular (or which have been used by this user in the past more often) will be nearer to the top of the list. Thus, for example, if the user has a record of accessing top 20 music content and types “6-2-6” during a search for an artist name, the user will see the “Mandy Moore” option as higher ranked than the “Nancy Sinatra” one, and the latter might even be totally omitted from the list. As another example, if the user is performing a flight booking search, and is looking for a flight from Paris and types 5-6-6, he or she is more like to be going to London in England than to Lome in Togo, so London will appear before Lome on the screen of the remote device, or Lome may not appear at all.

It is also important to note that in some cases there might exist an inherent ambiguity in the user entry, in the sense that two or more keywords or search terms that translate into the same exact sequence of key-presses. In this case, the algorithm will display all of these options as there is no sure way to know, prior to the user's confirmation, which of those options the user intended. For example, options displayed can be London, England, or London, Ontario, or Londonderry, Northern Ireland. The last city in this example may be eliminated if the user has stopped tying after the second “n”. The other two examples cannot be eliminated semantically, but may be eliminated historically if the server is aware, for example, that the user travels to London, Ontario, but has never traveled to London, England.

Once the list has been displayed, the user may provide feedback (e.g., provide more key-presses to disambiguate the chosen search term, choose from a menu) or if the list has narrowed down to just one option the server might switch automatically to the next stage in the interaction—playing the desired content, offering a menu of the content types, etc. Essentially, the user Confirms the Match 206, and them the system Retrieves the desired content and Renders the Content on the Remote Device Screen 207.

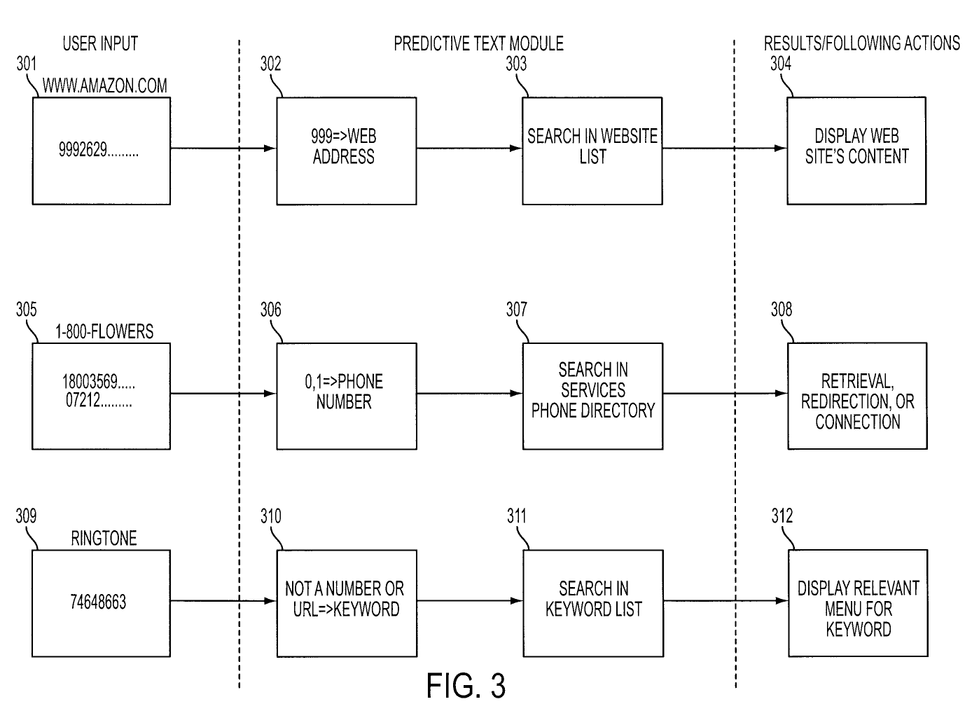

Three examples of possible services offered by some exemplary embodiments of the present invention are presented in FIG. 3.

### Example 1

Web Access: A predictive text input system could be used to direct users to services and content based on existing URLs, phone numbers, or keywords. For example, in User Input 301 the user indicates his or her desire for a URL Retrieval of the Amazon Website, by entering “w-w-w-a-m-a-z . . . ” which in DTMF encoding appears as 9-9-9-2-6-2-9- . . . . The Application Logic 302 recognizes this as a URL, and hence applies a predictive Search Operation Based on a List of Websites 303. The result of this analysis would be the Retrieval of the relevant website content, and, potentially after transcoding, resizing, or other conversion adaptation operations, Display of the Web Site's Content 304 on the screen of the Remote Device 101.

### Example 2

Telephone: The User Begins Telephone Number Key In 305. The Application Logic 306 detects this using the initial entry of “0” or “1” (typically used for toll free or service numbers). The system then Searches in Services Phone Directory 307, applying a predictive search operation based on a list of active phone numbers. The result of this analysis would be the Retrieval, Redirection, or Connection 308, meaning Retrieval of the relevant service content sent to and displayed on the remote device, or a redirection to the actual telephone number (or alternative telephone numbers), or connecting the user to the requested service immediately or in accordance with the user's instructions.

### Example 3

The User Begins Keyword Code-in 309. The Application Logic 310 detects this by the exclusion principle (by its form, not a URL or a phone number, therefore must be a keyword). The system then Searches a Keyword List 311, which is a predictive search operation based on list of keywords. The result would be then be Retrieval of content, and Display a Relevant Menu 312 on the Remote Device screen, after which the user would select and then receive the desired content. For example, if the initial keyword is “Ring-tone”, the menu displayed would be a menu of ring-tones, and the user would select the desired ring-tone for application on the user's Remote Device 101.

It should be noted that type of content ultimately displayed to the user is not necessarily tied to the type of access code used. For example, it could be that typing w-w-w-f-l-o-w-e-r-s-d-e-l-i-v-e-r-y-com, 1-800-flowers and the keyword flowers would all result in the same content and service direction, for example, to a short informational video about a flower delivery service, with potentially call creation to a human employee after/during the informational video.

Some exemplary embodiments of the present invention simplify the entry of search terms for users, and have particular value when there are numerous possible choices that cannot be conveniently narrowed down sufficiently so as to be displayed using numbered lists. In addition to the examples depicted in FIG. 3, some other sample applications would thus include:

Viewing movies or movie trailers based on movie name.

Viewing music clips based on the name of a the album, the barcode number of the album or the name of the artist.

Viewing bus/train/flight schedules and/or ordering tickets based on their number/name of company, travel origin or target etc.

Accessing web based content based on the website name.

Thus it becomes clear that an exemplary embodiment of the present invention has distinct advantages over the existing methods listed in the related art section.

Over Imaging—the needs for (1) a functional camera, (2) sufficient lighting, and (3) the symbol to image, are avoided.

Over Interactive Video Response—by avoiding or minimizing (1) the need for display screens and (2) forcing the user to choose among screens, very few entries are required and so the user data entry becomes much faster.

Over Interactive Voice Response (IVR)—the addition of the video channel (1) allows much faster interaction with the network. The user can see interactively the results of his or her input. This allows the server to offer options for the content/other information through the video channel, which is faster than the service of non-video systems. The delays of having the user listen to the server's guess etc. are all removed. The user does not need to hold the phone next to his ear—rather the user may type and operate in a mode similar to SMS sending. Another key value of the Video Call is that (like in WAP browsing) because of the visual medium it is much faster to present the user with many choices (typically ˜10 choices can be simultaneously presented on a handset's screen) than it is over a voice channel. Further, (2) it is much easier for the user to verify his or her input, and correct errors. It is also (3) easier for the user to verify that the content received is the content desired The fact that a phone need be held to the user's ear makes the data entry both faster and (4) less prone to error. Silent communication is simply much more resistant to environmental noise,

Over On Device Portals (ODPs)—by (1) eliminating the need for the installation of software on the remote device.

Over SMS—since the Video Call session is interactive, (1) the wait time associated with a back-and-forth SMS sequence is omitted. Furthermore, (2) when the user acknowledges the content identification through the video session the unwanted situation of user errors (as in the SMS typing) is avoided, and (3) the chances of sending the wrong content to the user are reduced.

Over Voice Recognition—exemplary embodiments of the present invention are (1) immune to environmental noise, and (2) can operate in complete silence thus affording better privacy and security for the end user.

Over WAP/Web browsing—in an exemplary embodiment of the present invention, (1) the user can type the desired code instead of clicking through multiple menus, (2) the server can provide feedback during the typing, (3) the server can apply predictive text input methods during the typing, (4) there is no need for a data plan to do the searching. In addition, (5) the server can also apply the correct language/alphanumeric versus numeric choices which a generic WAP browser cannot. For example, a Hebrew text based search engine could apply Hebrew characters without the user having to change any configuration on the phone (since the user is really just typing numeric keys and the server determines the meaning of these keys and what will appear on the phone's screen during the Video Call).

Over Voice Recognition—exemplary embodiments of the present invention are (1) immune to environmental noise, and (2) can operate in complete silence thus affording better privacy and security for the end user.

The foregoing description of the aspects of the exemplary embodiments of the present invention has been presented for purposes of illustration and description. It is not intended to be exhaustive or to limit the present invention to the precise form disclosed and modifications and variations are possible in light of the above teachings or may be acquired from practice of the present invention. The principles of the exemplary embodiments of the present invention and their practical applications were described in order to explain and to enable one skilled in the art to utilize the present invention in various embodiments and with various modifications as are suited to the particular use contemplated. Thus, while only certain aspects of the present invention have been specifically described herein, it will be apparent that numerous modifications may be made thereto without departing from the spirit and scope of the present invention.

What is claimed is:

1. A system for the retrieval of electronic information, comprising:
a remote device for inputting information requests, and for receiving and displaying received information;
a communication network for establishing a communication link between the remote device and an information network;
a protocol stack for receiving and decoding information requests from the remote device;
a real-time transport protocol (RTP) dispatcher for sending audio visual content to the protocol stack;
a video encoder for encoding video content in a format suitable for display on the remote device;
a dual tone multiple frequency (DTMF) decoder for determining what DTMF information was conveyed by the remote device;
a rendering engine for rendering on the screen of the remote device possible matches to the data entries being made by the user, and for starting delivering content to the user;
a predictive text input module for using information from the DTMF decoder and from a content database to predict words and numbers being entered by the user before the user has completed data entry; and
a content database with a stored list of potential inputs, used to help the predictive text input module predict the information request of the user before the user completes data entry.

2. The system of claim 1, wherein the communication link is a video call.

3. The system of claim 1, further comprising a short message service (SMS) handler for establishing a communication link between an SMS center and the communication network, and for sending messages through the communication network to the remote device.

4. The system of claim 1, further comprising a provisioning handler for determining if the user is eligible to receive a particular service.

5. The system of claim 1, further comprising a storage server for storing pre-prepared content clips.

6. The system of claim 1, wherein the communication link is a video call, and further comprising:
an SMS handler for establishing a communication link between a short message service (SMS) center and the communication network, and for sending messages through the communication network to the remote device;
a provisioning handler for determining if the user is eligible to receive a particular service; and
a storage server for storing pre-prepared content clips.

7. The system of claim 6, wherein the remote device is wireless.

8. The system of claim 7, wherein the remote device is a cellular telephone.

9. The system of claim 6, wherein input provided by the user comprises a plurality of DTMF signals.

10. The system of claim 6, wherein the remote device is wireline.

11. The system of claim 10, wherein the remote device is a wireline telephone.

12. The system of claim 11, wherein input provided by the user comprises a plurality of DTMF signals.

13. A method for retrieving electronic information, comprising:
a user pressing keys on a remote device to create new dual tone multiple frequency (DTMF) signals;
creating and expanding DTMF strings with the DTMF signals;
searching one or more databases for one or more matches between information stored in said databases and the DTMF strings;
determining if the number of matches found is at or below a threshold number;
if the number of matches is not at or below the threshold number, awaiting the input of new DTMF signals;
if the number of matches is at or below the threshold number, creating a list of matches and displaying said list on the screen of the remote device;
the user confirming the match that is desired; and
rendering informational content on the screen of the remote device, said informational content corresponding to the match confirmed by the user.

14. The method of claim 13, wherein the DTMF signals input by the user represent a Web address.

15. The method of claim 13, wherein the DTMF signals input by the user represent a telephone number.

16. The method of claim 13, wherein the DTMF signals input by the user represent a key word.

17. The method of claim 13, further comprising user input in form of audio signals.

18. The method of claim 13, wherein at least one of the databases comprise information supplied by a party or parties other than the user or a network manger.

19. The method of claim 13, wherein the database further comprises information supplied by at least one of the users and the network manager.

20. The method of claim 13, wherein:
the system determines that there is only one likely match between information stored in said databases and the DTMF strings.

21. The method of claim 13, wherein:
the user errs in the inputting of DTMF signals such that the user key presses create inaccurate DTMF strings;
the inaccurate DTMF strings are compared to information located in a system implementing the method;
the system identifies the inaccurate DTMF strings; and
the system sends to the user a notice identifying the inaccuracy, listing options for correct user input, requesting verification of input from the user, and requesting the user to select a choice representing the user's selection of a corrected input.

22. The method of claim 13, in which the user inputs DTMF signals such that the user key presses create DTMF strings that inherently have a plurality of possible meanings;
said DTMF strings with a plurality of possible meanings are compared to information located in a system implementing the method;
the system identifies the plurality of the possible meanings of the DTMF strings; and
the system sends to the user a notice identifying the possible meanings of the DTMF strings, listing said possible meanings as options for selection by the user, requesting verification of input from the user, and requesting the user to select a choice representing the possible meaning desired by the user.

23. The method of claim 21, further comprising:
the comparison of inputted DTMF signals to information in the system is performed at the predictive text input module;
the identification of inaccurate DTMF strings, verification of inaccuracy, and notice of request for selection, are performed at the predictive text input module.

24. The method of claim 22, further comprising:
the comparison of inputted DTMF signals to information in the system is performed at the predictive text input module;
the identification of possible meanings, and notice of request for selection, are performed at the predictive text input module.

25. The method of claim 13, wherein one or a plurality of the matches are transmitted to the remote device as part of an SMS message.

26. The method of claim 25, wherein the SMS message contains a Universal Resource Locator (URL) pointing to a site that contains information about one of the matches.

27. The method of claim 25, further comprising:
multiple informational content options being displayed on the screen of the remote device;
the user selecting one of said multiple informational content options; and
playing the informational content selected on the screen of the remote device.

28. The method of claim 27, in which the informational content is played on the screen of the remote device substantially immediately after the user has selected an informational content option.

29. The method of claim 27, wherein a delay between the time the user has selected an informational content option and the playing of the informational content on the screen of the remote device is provided.

30. The method of claim 27, wherein the multiple information options comprise video calls.

31. The method of claim 30, wherein the multiple information options further comprise contact information to a human operator.

32. The method of claim 31, wherein the multiple information options further comprise an invitation to establish communication with the human operator.

33. The method of claim 30, wherein the multiple information options comprise alphanumeric text.

34. The method of claim 30, wherein the multiple information options comprise ringtones.

35. The method of claim 30, wherein the number of video options displayed is based on ranking factors.

36. The method of claim 35, wherein the ranking factors comprise the type of remote device.

37. The method of claim 35, wherein the ranking factors comprise the quality of the image to be displayed on the remote device.

38. The method of claim 35, wherein the ranking factors comprise the history of past preferences of information accessed by the remote device on which the information request was inputted.

39. The method of claim 35, wherein the ranking factors comprise the relative popularity of the options.

40. The method of claim 36, wherein the ranking factors comprise past user behavior in accessing content from the system.

41. The method of claim 30, further comprising;
the predictive text input module determines the type of information requested by the user from the first few DTMF signals inputted by the user; and
the determination of the type of information requested by the user is based at least in part on the type of information inputted by the user.

42. The method of claim 41, wherein the type of information input by the user comprises a Web site.

43. The method of claim 41, wherein the type of information input by the user comprises a phone number.

44. The method of claim 41, wherein the type of information input by the user comprises a keyword.

45. The method of claim 41, wherein the type of information input by the user comprises a name.

46. The method of claim 45, wherein the name is the name of a business.

47. The method of claim 45, wherein the name is the name of a person.

48. The method of claim 45, wherein the name is the name of a work of art or music.

49. A method for retrieving electronic information, comprising:
a user pressing keys on a remote device to create new dual tone multiple frequency (DTMF) signals;
creating and expanding DTMF strings with the DTMF signals; and
searching one or more databases for one or more matches between the information stored in said databases and the DTMF strings.

50. The method of claim 49, further comprising:
determining that only one likely match between information stored in said databases and the DTMF strings exists; and
sending content to user related to the likely match.

51. The method of claim 49, in which:
the system sends an inquiry to the user to determine whether one likely match that the user intends exists;
if it is, the system begins sending to the user information content related to the likely match; and
if it is not, the system compares the DTMF strings with additional information stored in the databases until additional likely matches are found.
